(19) United States
(12) Patent Application Publication
(10) Pub. No.: US 2019/0125153 A1
(43) Pub. Date: May 2, 2019

(54) VACUUM WITH INTEGRATED FILTER CLEANING DEVICE

(71) Applicant: Dustless Depot, LLC, Price, UT (US)

(72) Inventors: Spencer Loveless, Price, UT (US); Kyle Alan Bjork, Buffalo, MN (US); Stephen Brent Willson, Price, UT (US)

(73) Assignee: Dustless Depot, LLC, Price, UT (US)

(21) Appl. No.: 15/797,943

(22) Filed: Oct. 30, 2017

(51) Int. Cl. A47L 9/20; A47L 9/00; A47L 5/36; A47L 9/16; A47L 9/12; A47L 9/10; A47L 7/00; B01D 45/16; B01D 46/00

(52) U.S. Cl. CPC A47L 9/20; A47L 9/0018; A47L 5/365; A47L 9/1683; A47L 9/1608; B01D 50/002; A47L 9/106; A47L 9/0072; A47L 7/0095; B01D 45/16; B01D 46/0068; A47L 9/125

(57) ABSTRACT

A vacuum cleaner and filter cleaning system includes a filter cleaning mechanism which allows the filter to be cleaned without removal from the vacuum. Operation of the filter cleaning mechanism both flows air backwards through the filter and strikes the filter to more effectively clean the vacuum filter. The vacuum allows for filter cleaning and debris disposal without significant interruption of the use of the vacuum cleaner.

### THE FIELD OF THE INVENTION

The present invention relates to vacuum cleaners. More specifically, the present invention relates to a high efficiency vacuum cleaner and a system for cleaning the filter on the vacuum cleaner.

### BACKGROUND

Vacuums are commonly used in both residential and industrial applications. Canister style vacuums with rigid filters in particular may be used for common applications such as vacuuming cars or cleaning in shops and garages as well as for more demanding applications such as for capturing dust from tools, cleaning fireplace ash, etc. Canister vacuums often have a pleated cylindrical filter inside of the debris canister. Large debris is deposited into the canister while dust is separated from the air by the filter.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 shows a perspective drawing of a vacuum.

FIG. 2A shows a partial cutaway drawing of the vacuum.

FIG. 2B shows a partial cutaway drawing of the vacuum.

FIG. 2C shows a partial cutaway drawing of the vacuum.

FIG. 3 shows a partial cutaway drawing of the vacuum.

FIG. 4 shows a partial cutaway drawing of the vacuum.

FIG. 5 shows a partial cutaway drawing of the vacuum.

FIG. 6 shows a partial cutaway drawing of the vacuum.

FIG. 7 shows a detailed drawing of the vacuum filter cleaning valve.

FIG. 8 shows a detailed drawing of the vacuum filter cleaning valve.

FIG. 9 shows a partial cutaway drawing of the vacuum

FIG. 10 shows a partial cutaway drawing of the vacuum

Corresponding reference characters indicate corresponding components throughout the several views of the drawings. Unless otherwise noted, the figures are drawn to scale to better illustrate the depicted elements. Skilled artisans will appreciate that elements in the figures are illustrated for simplicity and clarity. For example, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples.

The disclosure particularly describes a vacuum cleaner with a filter cleaning device. The present disclosure describes how filter cleaning device may be used to clean debris from a vacuum filter without removal of the filter from the vacuum. Cleaning the vacuum filter reduces pressure drop in air flow through the filter and maintains the performance and cleaning efficiency of the vacuum. Cleaning the filter without removal of the filter from the vacuum keeps the captured dust and debris inside of the vacuum. This keeps the surrounding area clean and minimizes exposure to the dust and debris captured by the vacuum. The resulting vacuum cleaner is a highly efficient vacuum cleaner which may be operated for longer periods of time between service. The vacuum cleaner maintains high airflow and works well for thorough cleaning as well as for demanding jobs such as collecting dust and debris from power tools.

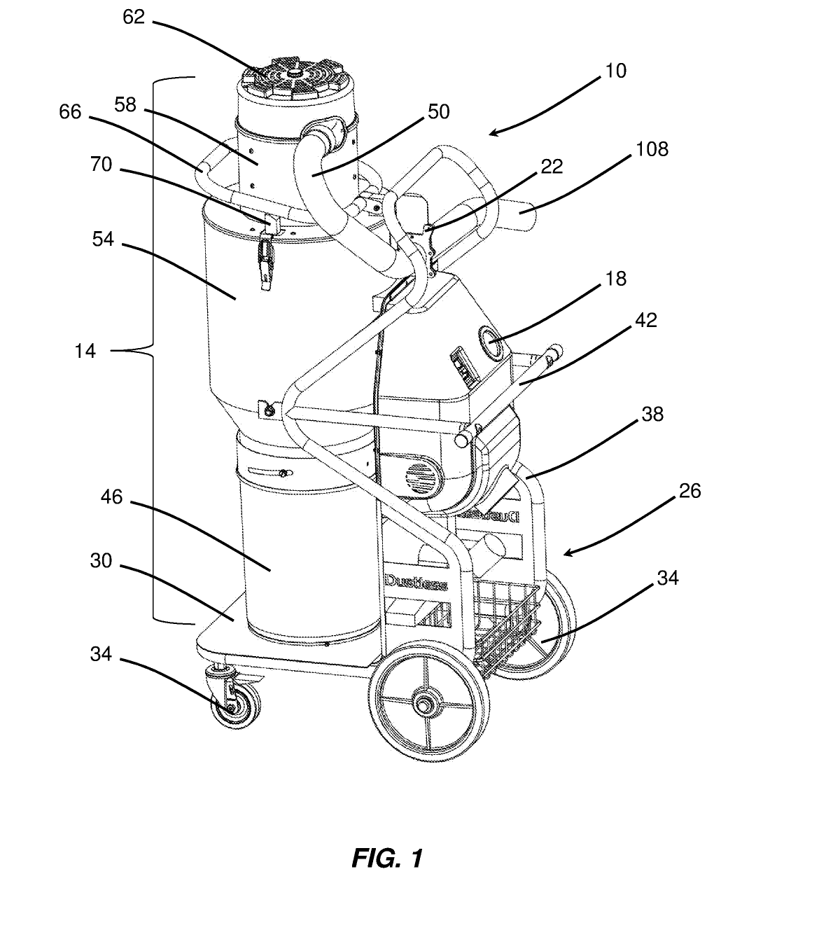

Turning now to FIG. 1, a perspective view of a vacuum is shown. The vacuum 10 can be used to vacuum up wet or dry debris. The vacuum 10 shown in the figures has been sized and configured to work best in an industrial setting. The vacuum 10 includes a vacuum body 14, a vacuum motor 18, and a vacuum inlet 22. The vacuum operates generally by drawing fluid into the vacuum inlet 22, through the vacuum body 14, and through the vacuum motor 18. The vacuum 10 typically operates by drawing in contaminant laden air and exhausting cleaned air. The vacuum body 14 contains the filtration system of the vacuum. The vacuum 10 is supported by a wheeled cart 26. The cart 26 includes a base 30 which supports the vacuum, wheels 34 which are attached to the base and which promote mobility of the vacuum, and a frame 38 which is attached to the vacuum 10 and which secures the vacuum 10 to the cart 26. Certain components of the vacuum, such as the motor 18 or inlet valve, may be alternatively attached to the vacuum body 14 or to the cart 26 or frame 38. The frame includes a handle 42 which is attached to the frame 38. The handle 42 provides a convenient way to move the vacuum and a place to store the vacuum motor electrical cord. If desired, the handle 42 could be pivotably attached to the frame 38 and constructed so that the distal end of the handle 42 is attached to the vacuum body 14. Pushing the proximal end of the handle 42 downwardly may lift the vacuum body 14 relative to the frame 34 to lift the vacuum body 14 above a debris canister 46 and make it easier to empty the debris canister 46.

The inlet valve 22 may be mounted to the frame 38 or onto the vacuum body 14, and may include a short inlet section of vacuum hose 50 or conduit connecting the inlet valve to the inlet of the vacuum body 14 (i.e. the inlet to the vacuum filtration system). Alternatively, the inlet hose 50 may be omitted and the inlet valve 22 may be mounted directly to the vacuum body 14 at the inlet to the vacuum filter. The inlet valve 22 may be opened and closed to selectively allow or block airflow through the vacuum and is primarily used as part of the filter cleaning system.

The vacuum body 14 is formed from a main body section 54, a lid 58, and an air cleaner inlet 62. The main body section 54 and the lid 58 together house a high efficiency cyclone separator and a high efficiency particulate air (HEPA) filter. The main body 54 and the lid 58 attach together and enclose the filtration system (the cyclone and the filter). The debris canister 46 is attached to the bottom of the main body 54 and receives debris from the main body. The debris canister 46 is isolated from the interior of the vacuum during vacuum operation by a dump plate. Accordingly, the vacuum 10 may be operated with a garbage bag instead of the debris canister 46. In some applications, this may make it easier to dispose of the debris collected by the vacuum 10. The exterior of the vacuum 10 also includes a filter cleaning handle 66 which is pivotably attached to the vacuum 10 and a filter cleaning valve/striker 70 which is attached to the vacuum 10 and operated by the filter cleaning handle 66.

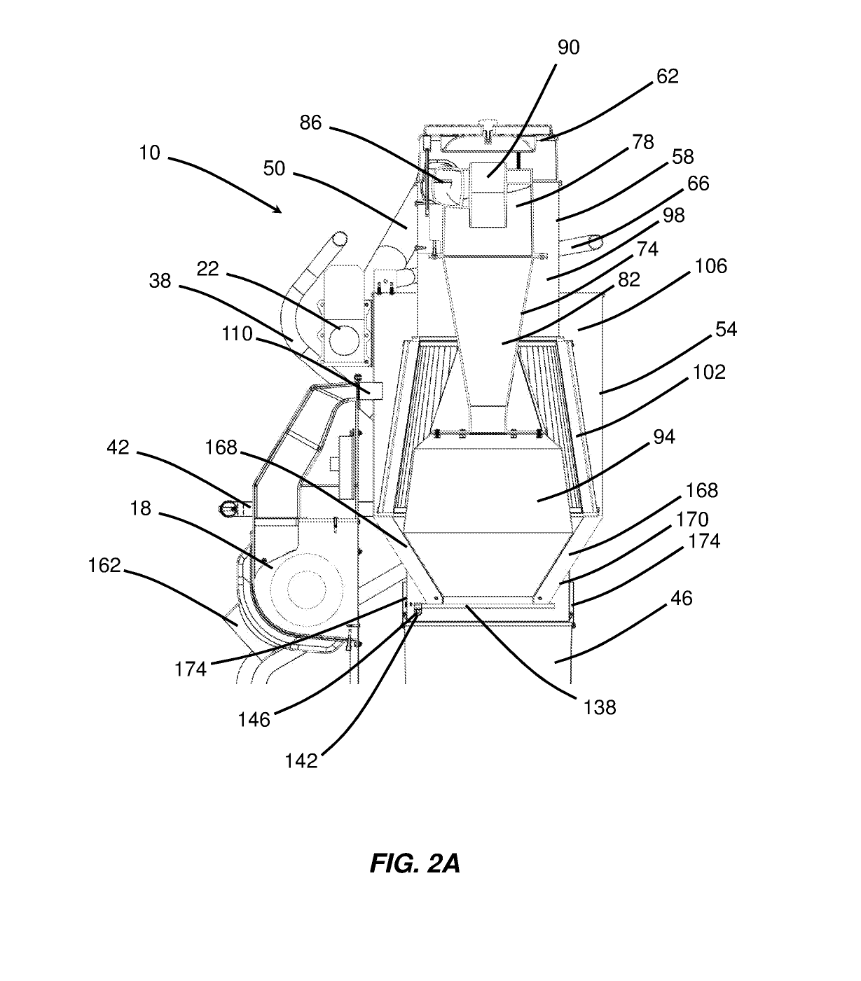

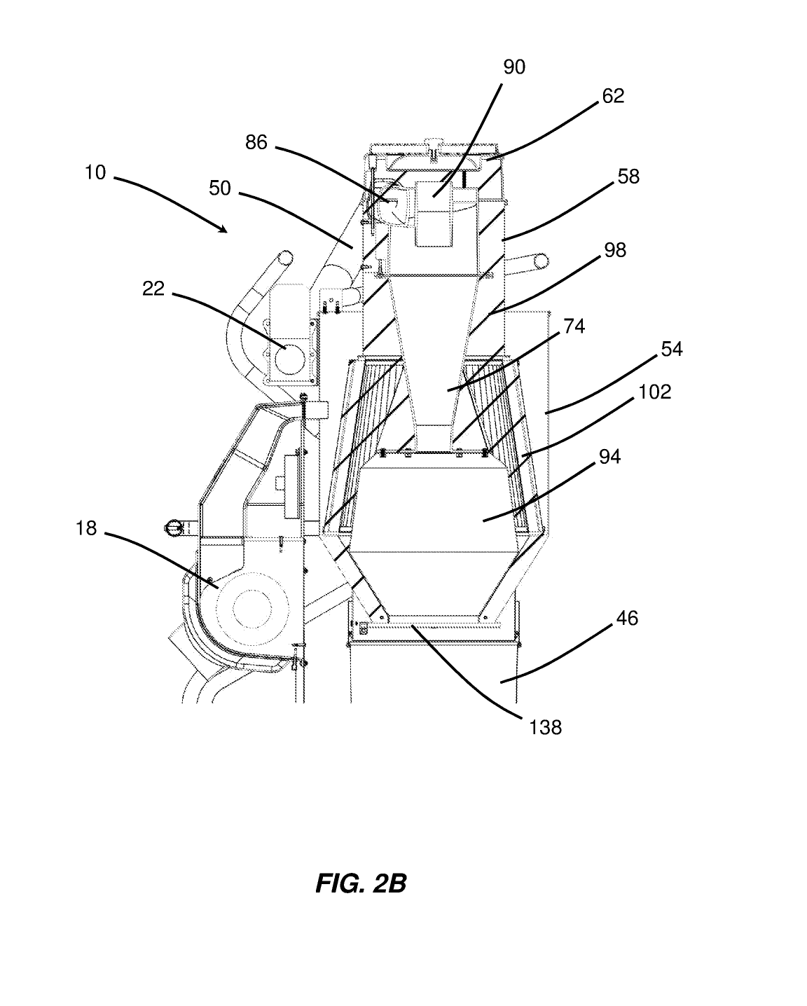

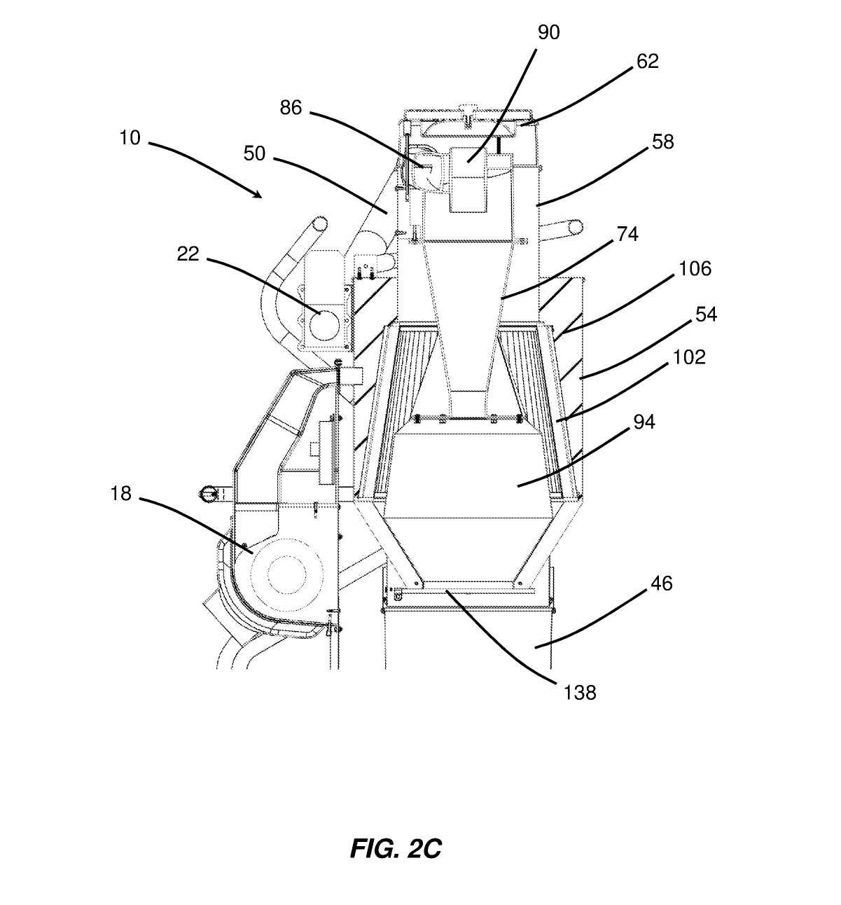

FIG. 2A shows a cut-away view of the vacuum 10 and illustrates the internal filtration system of the vacuum 10. The cyclone filter 74 is attached to the lid 58 and includes an upper inlet section 78 and a lower conical section 82. The upper inlet section 78 of the cyclone 74 is attached to the lid and may be separable from the lower conical section 82 of the cyclone when the vacuum lid 58 is removed from the vacuum body. This can facilitate cleaning of the cyclone or servicing of the vacuum 10. The lower conical section 82 of the cyclone 74 is attached to the debris collection bin 94. Such an arrangement makes it easier to replace the filter 102 if needed. The upper inlet section 78 of the cyclone 74 includes an air inlet 86 which is connected to the inlet valve 22 by the inlet hose 50. The inlet valve could also be mounted directly to the vacuum lid 58 and the inlet hose 50 could be omitted. The air inlet 86 angles downwardly into the cyclone inlet section 78 to guide the incoming air into a downward spiral. The upper inlet section 78 of the cyclone 74 also includes a cyclone air outlet 90. The lower conical section 82 of the cyclone 74 extends downwardly from the upper inlet section 78 and tapers in diameter. The lower opening of the lower conical section 78 is attached to and open to an internal debris collection bin 94. Debris laden air enters the cyclone air inlet 86 and spirals around the cyclone and downwardly. The debris is held against the outer wall of the cyclone 74 and spirals downwardly into the debris collection bin 94 while cleaned air moves towards the center of the cyclone and exits upwardly through the cyclone air outlet 90.

Air exiting through the cyclone air outlet 90 enters into a first, upper plenum 98 which is formed between the cyclone 74 and the lid 58, between the cyclone 74 and the filter 102, as well as between the upper portion of the debris collection bin 94 and the filter 102. This upper plenum 98 is generally cylindrical and is located in an annular space surrounding the cyclone 74 and the debris collection bin 94 and inside of the lid 58 and filter 102.

The filter 102 is a rigid filter and is generally cylindrical and disposed with its central axis in a vertical orientation. The filter 102 tapers vertically and has an upper diameter which is smaller than its lower diameter. Air flows through the filter 102 from the inside of the filter 102 to the outside of the filter 102. Accordingly, debris in the air is deposited on the inside surface of the filter 102. Because the upper end of the filter 102 is smaller in diameter than the lower end of the filter 102, debris falling from the filter does not impact a lower section of the filter; instead falling cleanly away from the filter 102. The filter 102 seals against a bottom portion of the lid 58 and also seals against a bottom portion of the main body section 54 and is held rigidly between these while in use. As shown, the lid 58 may include a generally horizontal lower plate that seals against the upper opening of the main body section 54 and a generally cylindrical upper portion that extends around the upper portion of the cyclone 74 and creates an annular space around the cyclone 74 between the lid 58 and the cyclone 74. This cylindrical upper portion may extend downwardly and seal against the top of the filter 102.

A second, lower plenum 106 is formed between the filter 102 and the main body section 54. The second, lower plenum 106 is separated from the first, upper plenum 98. Air flows from the first plenum 98 into the second plenum 106 by passing through the filter 102. The filter 102 ensures that any air exiting the cyclone is thoroughly cleaned before being exhausted into the atmosphere. Air exits the second plenum 106 through an exit port 110 and passes into the vacuum motor 18. The vacuum motor 18 powers the vacuum and includes a motor and blower unit forming an air pump (typically a centrifugal cage type blower), cords, switches and electronics necessary to operate the motor, ducting to handle the movement of the air, and an air outlet to the atmosphere. The motor draws air through the vacuum 10 and its air cleaning system. FIGS. 2B and 2C show cutaway views of the vacuum 10 to illustrate the upstream plenum 98 the downstream plenum 106. FIG. 2B indicates the upstream plenum 98 with dashed lines. FIG. 2C indicates the downstream plenum 106 with dashed lines.

The filtration system is arranged in a coaxial arrangement, with the cyclone 74 placed vertically over the debris collection bin 94 and with the vertical axes of these two components aligned. The filter 102 is placed coaxially around the cyclone 74 and debris collection bin 94. The lid 58 is arranged coaxially around the cyclone 74 with aligned axes and forms an annular first plenum around the cyclone 74. The main body section 54 is arranged coaxially around the cyclone 74, filter 102, and debris collection bin 94 and these share a common axis. The second plenum 106 is arranged annularly around the filter 102.

The air cleaner inlet 62 is located at the top of the vacuum lid 58. The air cleaner inlet 62 includes a valve that may be selectively opened and closed to allow ambient air from around the vacuum into the vacuum filtration system. In one embodiment, the air cleaner inlet 62 may allow air from the environment to enter directly into the upstream plenum 98. This air is then passed through the filter 102 and into the downstream plenum 106. Since the air surrounding the vacuum often has a small amount of entrained dust, it may not be necessary to pass this air through the cyclone 74. In another embodiment, the air cleaner inlet 62 may include a valve and a conduit connecting the valve to the cyclone air inlet 86. Environmental air entering through the air cleaner inlet 62 is then passed into the cyclone 74 with the other air moving through the vacuum 10. This may be desirable if the environmental air surrounding the vacuum 10 has a higher degree of entrained dust. In such a configuration, the inner side of the air cleaner inlet 62 is fluidly connected to the air inlet 86 of the cyclone 74. For example, the inside of the air cleaner inlet could be formed into a pipe or conduit and could merge into the inlet hose 50 or cyclone inlet 86 with a Y-connector. When the room air cleaner inlet 62 is open, a portion of the airflow through the vacuum 10 flows into the vacuum 10 through the inlet valve 22 (indicated by arrow 114) and a portion of the airflow through the vacuum 10 flows into the vacuum 10 through the room air cleaner inlet 62 (indicated by arrow 118). If the air cleaner inlet 62 is closed, no air enters through the air cleaner inlet 62 and all air enters the vacuum through the inlet valve 22.

In operation of the vacuum, the inlet valve 22 is connected to a vacuum hose 108 (shown partially in FIG. 1). The vacuum hose is typically between about 4 and about 12 feet long and connects the vacuum to a desired object to collect debris. In some instances, the vacuum hose 108 is connected to a vacuuming wand or another attachment to clean a room or other area. In other instances, the vacuum hose 108 is connected to a dust shroud of a power tool to collect dust generated by the tool during use. For example, the vacuum hose 108 may be connected to a dust collection shroud on a concrete grinder or cutter to collect the concrete dust produced while cutting or grinding concrete. In use, these tool dust collection shrouds are often not 100 percent efficient and allow a small amount of the dust to escape. This dust tends to be fine dust which is suspended in the room air.

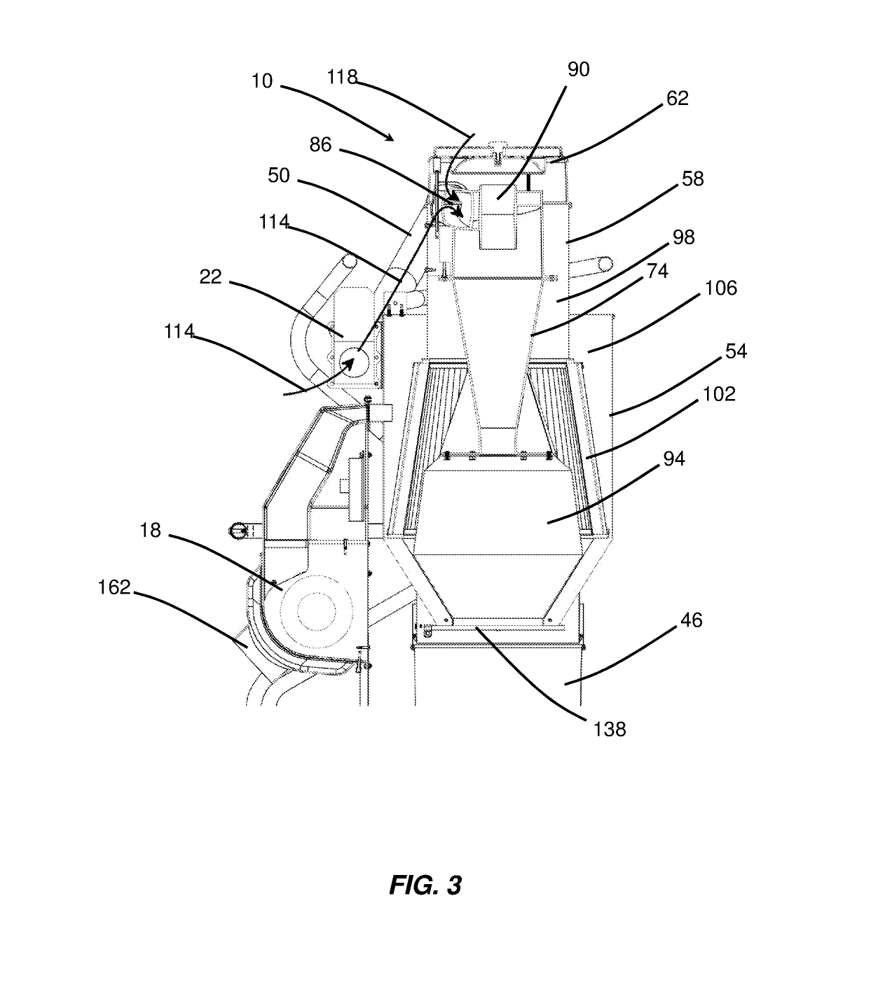

The air cleaner inlet 62 is a bypass inlet which allows air from the room or area surrounding the vacuum 10 to enter into the vacuum 10 independent of the air inlet 22 which is typically used in conjunction with a dust producing tool or for a particular cleaning task. FIG. 3 illustrates how the room air cleaner inlet 62 allows a majority of the airflow through the vacuum 10 to be used for a particular task (airflow indicated by arrow 114) while allocating a smaller portion of the airflow through the vacuum to be used for generally reducing airborne dust in the area around the vacuum 10 (airflow indicated by arrow 118), or alternatively allowing a large amount of air to enter through the air cleaner inlet 62. The room air cleaner inlet 62 may be a rotary gate valve which may be turned between an open position where air surrounding the vacuum 10 is drawn through the valve and a closed position where air surrounding the vacuum 10 is not drawn into the vacuum. For example, the room air cleaner inlet 62 may have an internal cap with a number of vanes arranged in a radial pattern with opening therebetween and an external cap which fits over the internal cap and has corresponding vanes and openings. Turning the external cap may selectively align the openings to allow flow or distribute the vanes to block flow.

Typically, the majority of the airflow will enter the vacuum through the inlet valve 22 as this air is used to collect debris from a tool or is otherwise being actively used by a person to collect dust and debris. The room air cleaner inlet valve 62 may be sized according to the amount of air that should pass through it. If the air cleaner inlet 62 is made sufficiently large, a large amount of air could pass through the room air cleaner inlet 62. This may be desirable to allow for quick cleaning of ambient air if the room air becomes unexpectedly dirty. The air cleaner inlet 62 may be adjusted proportionately, allowing a person to select between a large amount of air, a small amount of air, and no room air entering into the vacuum 10 through the air cleaner inlet 62.

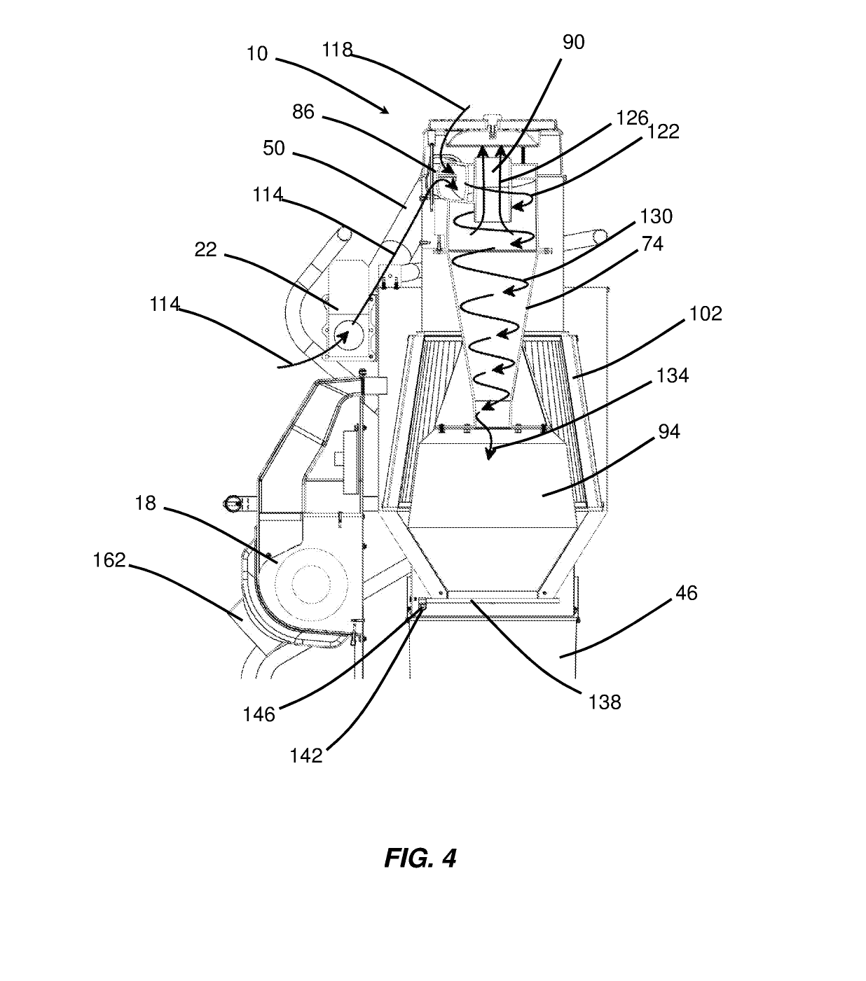

FIG. 4 illustrates the pathway of debris and air into the vacuum 10 and through the cyclone 74 when the vacuum 10 is operated. Debris laden inlet air 114, 118 is drawn into the vacuum 10 and enters the cyclone 74 through the cyclone air inlet 86. As shown, the cyclone air inlet 86 is facing out of the page towards the viewer. The cyclone air inlet 86 is oriented downwardly and tangentially to the outer wall of the upper inlet section 78 of the cyclone 74. Air and debris entering the cyclone 74 is spun counter-clockwise as viewed from above, crossing in front of the cyclone air outlet 90 and around the back of the cyclone upper inlet section 78. This movement of air and debris through the cyclone upper inlet section 78 is shown by arrow 122. Air and debris spirals downwardly around the outer wall of the cyclone 74. The inertia of the debris particles tending to move them in a straight line causes them to move close to the wall of the cyclone 74. Once the air and debris passes below the cyclone air outlet 90, clean air which is largely free of debris exits the cyclone from the middle of the cyclone body as shown by arrow 126. Debris continues to spiral downwardly through the lower conical section 82 of the cyclone 47 as indicated by arrow 130. Once this debris reaches the bottom of the lower conical section 82 of the cyclone 74, it is deposited into the debris collection bin 94 as indicated by arrow 134. The bottom opening of the cyclone is generally the same size as the upper opening of the debris collection bin 94.

Debris collected by the cyclone 74 is retained in the debris collection bin 94 until this bin is emptied into the debris canister 46. The bottom of the debris collection bin 94 is closed by a dump plate 138. The dump plate 138 is attached to the body 54 of the vacuum 10 by a pivot 142. The dump plate 138 may pivot downwardly and away from the debris collection bin 94 about the pivot 142 to allow debris from the debris collection bin 94 to move into the debris canister 46. A spring 146, such as a coil spring, may be disposed about the pivot 142 and attached to the vacuum body 54 and dump plate 138. The spring 146 may be selected to support the weight of the dump plate 138 so that the dump plate is largely balanced in a horizontal position by the spring. When the vacuum 10 is operating, the negative pressure within the vacuum 10 holds the dump plate 138 securely closed. When the vacuum 10 is not operating, debris weight on the dump plate 138 will cause the dump plate 138 to open and deposit debris into the debris canister 46. Once the debris is off of the dump plate 138, the dump plate closes due to the bias of the spring 146.

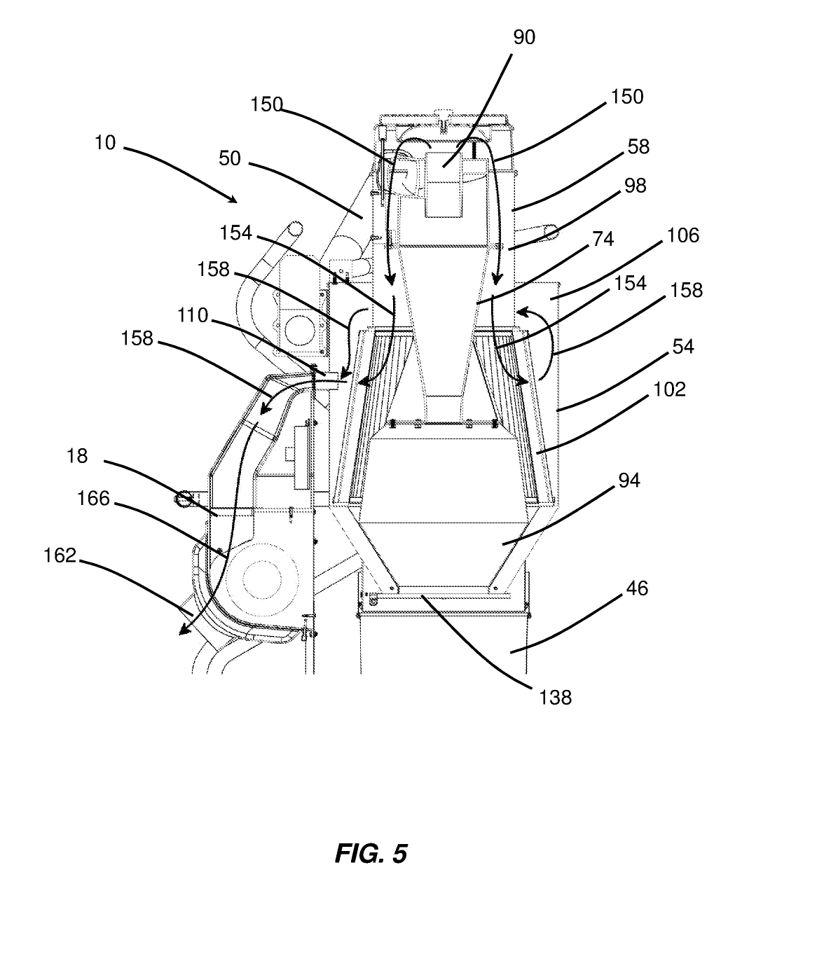

FIG. 5 illustrates the pathway of air moving out of the vacuum from the upper, first plenum. Air which has exited the cyclone 74 moves around the cyclone coaxially into the upper, first plenum 98 as indicated by arrows 150. This air moves downwardly into the annular space between the cyclone 74/debris collection bin 94 and the rigid HEPA filter 102 as indicated by arrows 154. This air moves through the filter 102 and into the outer, second plenum 106. The filter 102 removes any remaining amount of dust in the air. As the cyclone 74 removes nearly all of the debris from the air, only a small amount of dust remains. This reduces the load on the filter 102 and allows the vacuum 10 to maintain a high level of airflow while collecting debris. Once into the second plenum 106, air moves towards the exit port 110 and into the vacuum motor 18 as indicated by arrows 158. The vacuum motor 18 moves the air out of the vacuum through an exit vent 162 as indicated by arrow 166.

The main body section 54 and debris collection bin 94 are shaped so that an annular space 168 is present between the debris collection bin 94 and the main body section. The main body section 54 may be formed with a tapering lower section 170 which is spaced apart from the bottom of the debris collection bin 94. The dump plate 138 may close both the bottom of the debris collection bin 94 and the bottom opening of the tapering lower section 170. A mounting collar 174 which is larger in diameter than the bottom of the tapering lower section 170 may be attached to the tapering lower section 170. The mounting collar 174 is used to attach the debris canister 46 to the vacuum 10. In one configuration, the mounting collar 174 may include a stationary collar attached to the lower section 170 of the vacuum and a movable mounting collar which can rotate about the stationary collar and also move vertically about the stationary collar. This rotating collar can be rotated to lock the debris canister 46 to the vacuum 10 and can be moved vertically to facilitate removal and emptying of the debris canister 46.

When the vacuum is in use, debris in the debris collection bin 94 falls on top of the dump plate 138. Debris which is collected by the filter 102 may also fall from the filter into the annular space 168 on top of the dump plate. When the vacuum motor 18 is not operating, the dump plate 138 may swing downwardly to open and dump debris from both the filter 102 and the debris collection bin 94 into the debris canister 46.

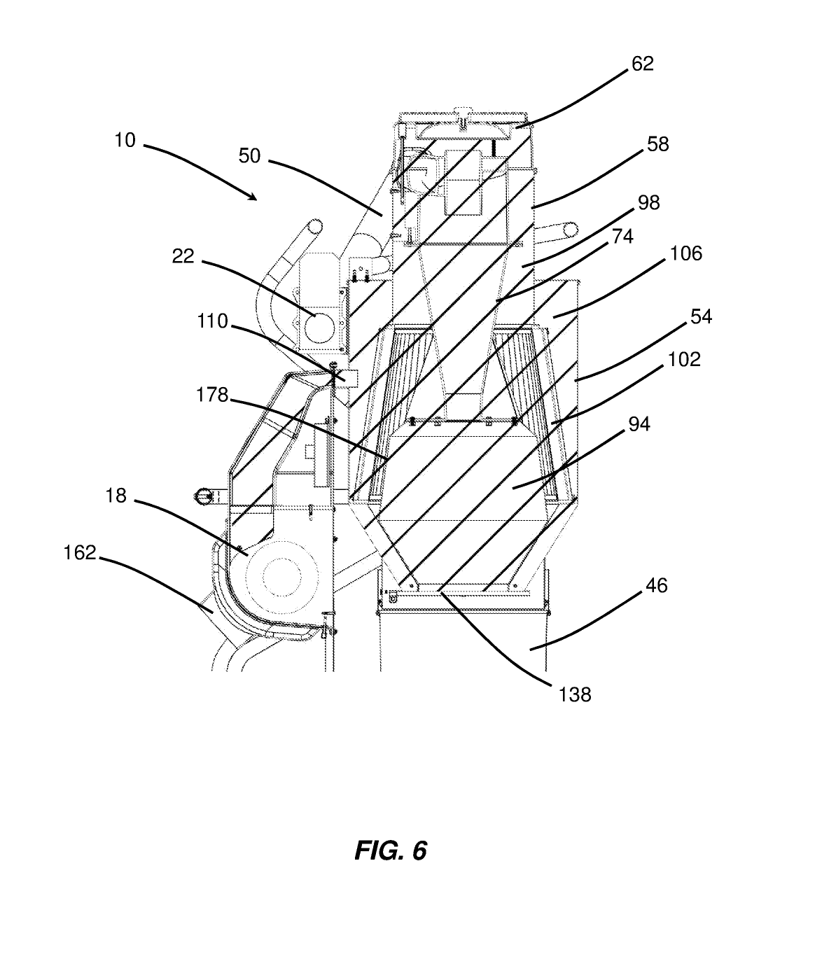

FIGS. 6 through 9 illustrate the process by which the filter 102 is cleaned. As discussed, the vacuum 10 is designed so that a majority of the debris is collected by the cyclone 74 and does not contact the filter 102. This maintains air flow through the vacuum 10, prolongs the life of the filter 102, and extends the cleaning interval for the filter. The filter 102 is designed to facilitate cleaning the filter without removal from the vacuum 10. The filter 102 is frustoconical in shape; having tapering sidewalls so that one end of the filter is smaller than the other end of the filter. Both ends of the filter 102 are open. The filter 102 is mounted in the vacuum so that the smaller end of the filter 102 is up and the larger end of the filter 102 is down. The upper end of the filter 102 seals against the vacuum lid 58 and is in communication with the vacuum plenum 98. The lower end of the filter 102 seals against the vacuum main body 54. The shape of the filter allows debris from the filter 102 to fall away from the filter and into the lower part of the vacuum body 54.

In order to clean the filter 102, the inlet valve 22 and room air cleaner inlet 62 are closed while the motor 18 is operating. This evacuates air from the interior of the vacuum 10 and places the part of the vacuum 10 indicated in FIG. 6 with dashed lines 178 in a state of vacuum. After a short period of time, the air pressure within the vacuum 10 stabilizes at the amount of vacuum which can be drawn by the motor 18. Once the reduced air pressure within the vacuum 10 is stabilized, the filter cleaning lever 66 is moved downward by the vacuum operator. This operates the filter cleaning valve 70.

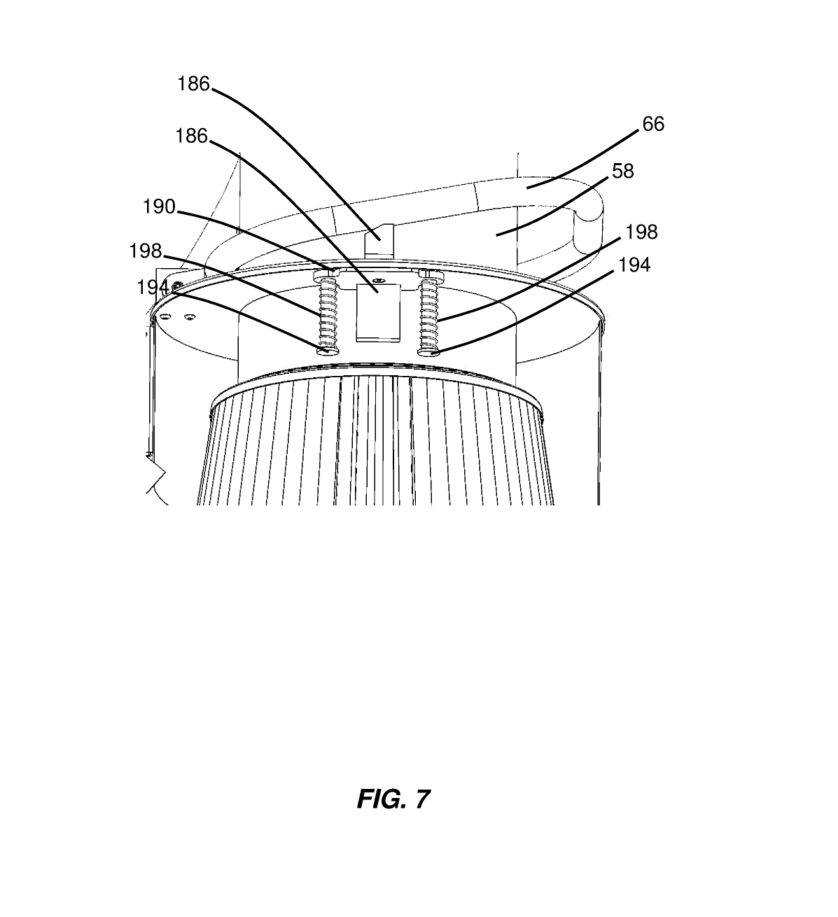

FIG. 7 shows a detailed view of the filter cleaning valve 70 in a closed position. The filter cleaning valve 70 includes a central stem 186 which extends through the vacuum lid 58. The stem 186 extends above the vacuum lid 58 and is disposed beneath the filter cleaning lever 66. The stem 186 extends beneath the vacuum lid 58 and is disposed above the upper rim of the vacuum filter 102. A seal plate 190 is attached to the stem 186 and is located beneath the vacuum lid 58. Two guide posts 194 are attached to the vacuum lid 58 and the seal plate 190 engages the guide posts 194. The seal plate 190 can slide up and down along the guide posts 194 and the stem 186 travels with the seal plate 190. Two springs 198 are disposed around the guide posts 194 and bias the seal plate up against the vacuum lid 58.

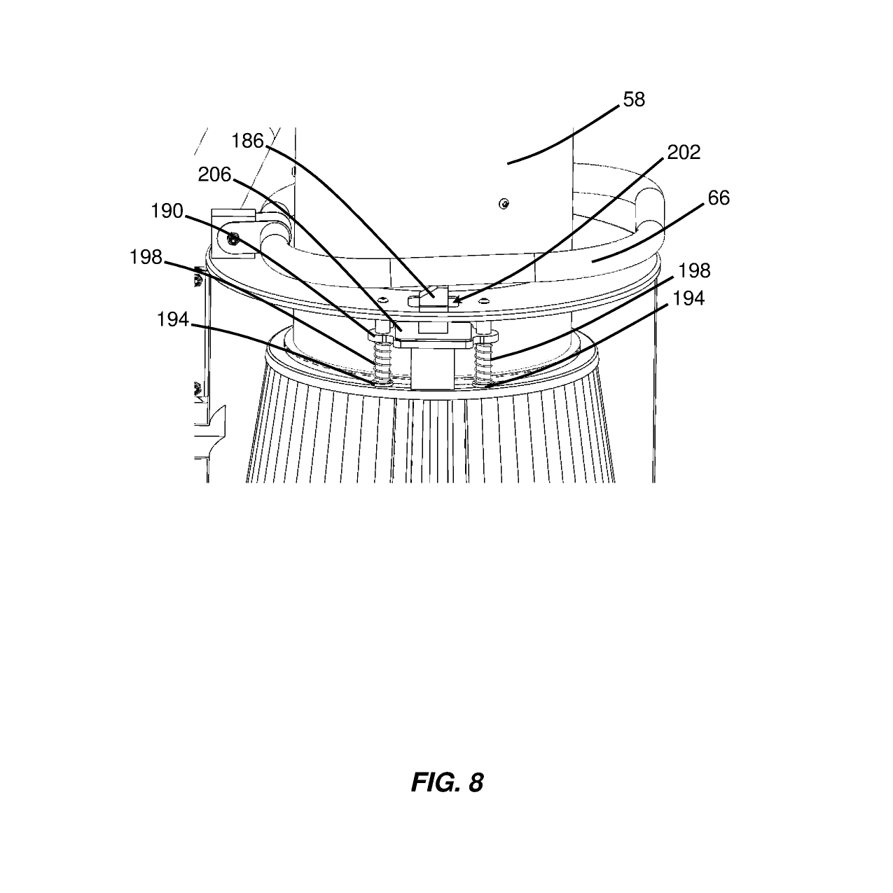

FIG. 8 shows a detailed view of the filter cleaning valve 70 in an open position. As shown, a hole 202 is formed in the vacuum lid 58. When the vacuum cleaning valve 70 is closed, the seal plate 190 closes the hole 202 and the vacuum operates as discussed above. A rubber seal 206 may be attached to the top of the seal plate 190 to assist the seal plate in sealing the hole 202 and preventing air flow therethrough. When the filter cleaning lever 166 is moved down, it contacts the top of the stem 186 and moves the stem 186 and seal plate 190 downwardly. This accomplishes two things at substantially the same time. First, the hole 202 is open, allowing air flow into the vacuum 10. Second, the stem 186 knocks against the filter 102. The impact of the stem 186 hitting the filter 102 dislodges debris from the filter. The vacuum operator may move the filter cleaning lever 66 up and down a few times to cause the stem 186 to hit the filter a few times.

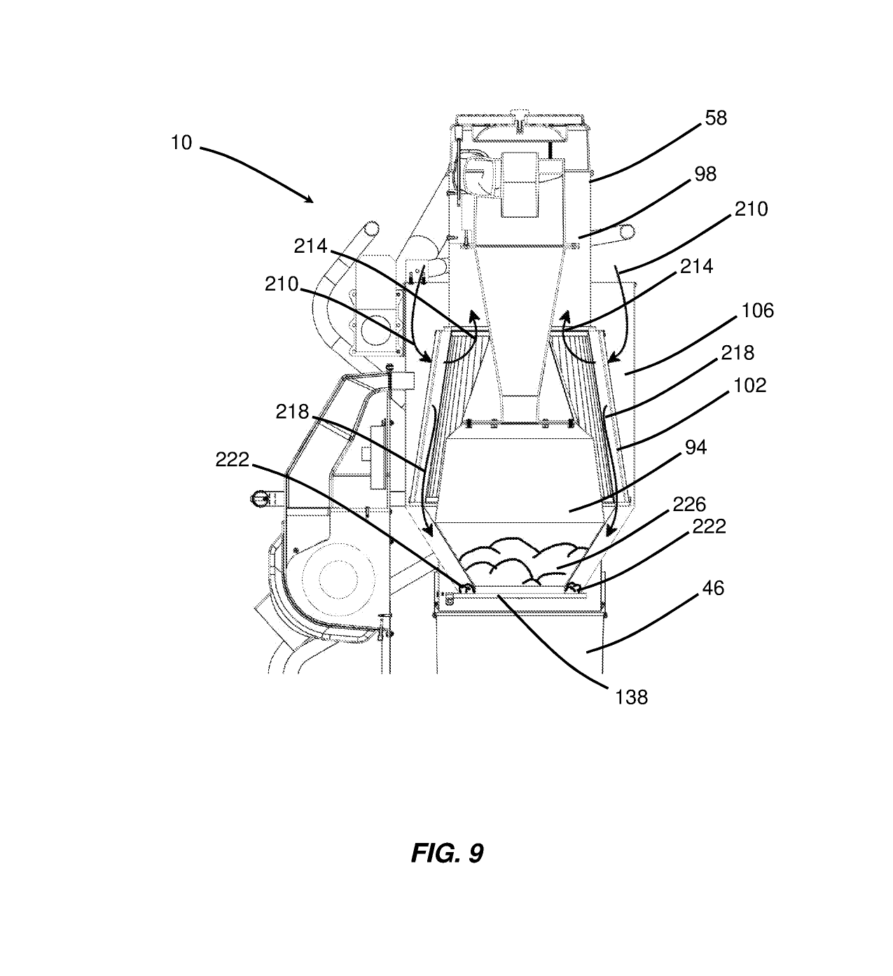

FIG. 9 shows the flow of air through the vacuum 10 once the filter cleaning valve 70 is open. Air moves through the hole 202 of the filter cleaning valve 70 and into the second plenum 106 as indicated by arrows 210. This air moves through the filter 102 in a reversed direction relative to normal vacuum operation in order to equalize the low air pressure in the first plenum 98 as indicated by arrows 214. The combination of the reversed air flow and the filter cleaning valve 70 striking the filter 102 dislodges debris from the filter 102. The dislodged debris falls downwardly into the space 168 and against the dump plate 138 as indicated by arrows 218. FIG. 9 shows how filter debris 222 and cyclone debris 226 both rest against the dump plate 138 where they do not interfere with the operation of the vacuum 10.

The cleaning valve 70 is advantageous as it cleans the filter better than previous vacuum designs. The filter cleaning valve 70 strikes the filter 102 precisely while airflow is reversed through the filter 102 due to the vacuum condition present in the vacuum 10. The reversed air flow lasts only momentarily and the filter cleaning valve 70 causes the reversed airflow and the filter striking to occur substantially simultaneously. This significantly improves filter cleaning over reversed airflow or filter striking alone (or not simultaneously occurring).

Prior art vacuums which strike the filter do this without simultaneous airflow reversal. Prior art vacuums which reverse the airflow do this without simultaneously striking the filter. Additionally, prior art vacuums which reverse the airflow do so at the expense of filter cleaning or room cleanliness. Known single filter designs which reverse airflow through the filter will vent airflow and debris out of the vacuum as the motor flow is redirected through the filter backwards to clean the filter. Since the motor airflow is used to clean the filter, a corresponding airflow must be vented out of the vacuum in order to permit flow through the filter. This defect has been addressed by using two filters and two motors. One motor is reversed while the other motor operates normally. This recirculates air in the vacuum and avoids venting during filter cleaning, but filter cleaning is degraded as debris from the filter being cleaned deposits on the filter operating normally. Additionally, the vacuum suffers from increased cost and complexity as two motors and filters as well as additional plumbing are required.

The present design avoids these drawbacks. Because the reversal of airflow through the filter 102 is caused by an initial vacuum drawdown of the vacuum 10 and subsequent venting of air into the vacuum 10, no air is vented from the vacuum. The vacuum motor 18 operates normally at all time drawing air from the vacuum 10 and all air exiting the vacuum 10 is from the clean side of the filter 102. All collected debris is maintained in the vacuum 10. Even if the valve 22 were opened during cleaning, no air would be vented as the vacuum 10 is under negative pressure and not positive pressure. Filter cleaning would be lessened, but the environment around the vacuum 10 would not be dirtied by venting air and debris. The near simultaneous reversal of airflow through the filter 102 and the striking of the filter 102 by the filter cleaning valve 70 greatly improves the removal of debris from the filter 102. This manner of reversing airflow through the filter 102 is provided by the upstream first plenum 98 and the downstream second plenum 106 separated by the filter 102. The filter cleaning valve 70 vents air into the second, downstream plenum between the vacuum motor 18 and the filter 102. In one embodiment, two filter cleaning valves are located on opposite sides of the vacuum lid 58 and are both operated by a filter cleaning handle/lever 66 which extends around the center of the vacuum lid 58 and operates both filter cleaning valves simultaneously.

If desired, the filter 102 may be cleaned multiple times simultaneously. If the filter cleaning lever 66 is elevated, the filter cleaning valve 70 closes and the motor 18 again evacuates air from the vacuum 10 and creates a negative pressure in the vacuum 10. Depression of the filter cleaning lever 66 again opens the filter cleaning valve 70, reversing air flow through the filter 102 and striking the filter 102 near simultaneously. The design avoids the complexity of prior art vacuums, and only requires the operator to close the vacuum inlet valve 22 and, when ready, move the filter cleaning lever 66 as often as desired to clean the filter 102.

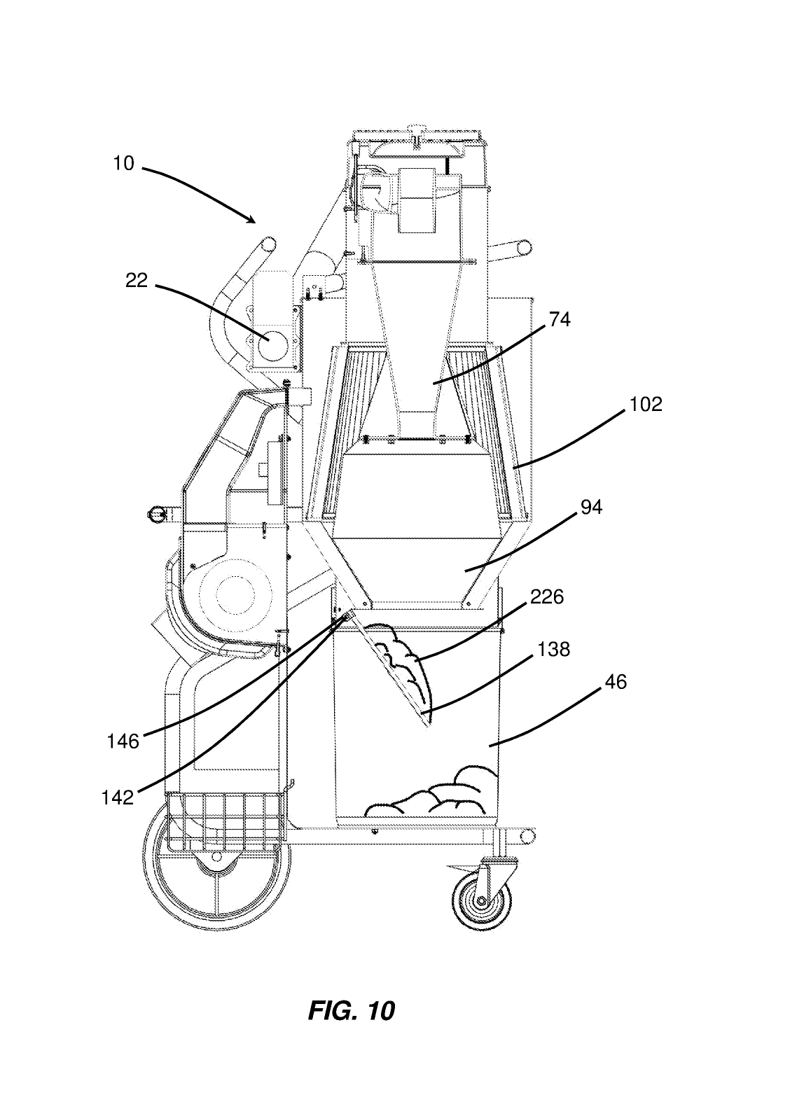

FIG. 10 shows how the dump plate 138 opens to empty the debris collection bin 94 and the vacuum body 54. As discussed, the dump plate 138 is mounted to a pivot 142 and uses a spring 146 to offset the weight of the dump plate 138 and bias the dump plate upwardly against the bottom of the debris collection bin 94 and the vacuum body 54. The spring 146 may be chosen so that the dump plate is neutrally balanced around the pivot 142. In one configuration, the spring 146 is sufficiently strong to pivot the dump plate 138 upwardly against the debris collection bin 94 while allowing the dump plate 138 to pivot downwardly if there are several ounces of weight on the dump plate. This allows the dump plate 138 to open when the vacuum 10 is off and deposit debris into the debris canister 46 and then close itself afterwards. The area of the dump plate 138 exposed to the internal reduced pressure of the vacuum 10 during operation of the vacuum 10 applies a substantial force to the dump plate 138 which holds the dump plate 138 securely closed while the vacuum is operated. If the spring 146 is selected appropriately, the dump plate 138 may be made to open during filter cleaning after opening the filter cleaning valve 70 and allowing the internal reduced pressure to equalize.

The debris collection canister 46 may be attached to the mounting collar 174 in an air-tight manner to keep dust and debris contained while being transferred between the vacuum 10 and the debris collection canister 46. The dump plate 138 isolates the debris canister 46 from the interior of the vacuum 10 during normal operation of the vacuum 10; allowing the debris canister 46 to be removed from the vacuum 10 and emptied while the vacuum 10 remains is used.

The above description of illustrated examples of the present invention, including what is described in the Abstract, are not intended to be exhaustive or to be limitation to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A vacuum cleaner comprising:
a vacuum body;
an air inlet which receives debris laden air into the vacuum body;
a filter disposed in the vacuum body which removes debris from the debris laden air;
an air outlet port in the vacuum body;
a vacuum motor connected to the air outlet port which operates to draw air from the vacuum body and thereby create airflow into the air inlet and through the filter; and
a filter cleaning valve in the vacuum body which is openable to vent air into the vacuum body from the environment surrounding the vacuum; wherein the vent air travels through the filter in a direction which is in reverse of normal vacuum operation to thereby clean the filter.

2. The vacuum cleaner of claim 1, wherein the vacuum comprises an upstream plenum disposed between the air inlet and the filter and a downstream plenum disposed between the filter and the air outlet, and wherein the filter cleaning valve is openable to vent atmospheric air into the downstream plenum.

3. The vacuum cleaner of claim 1, wherein the vacuum comprises an air inlet valve which is closable to stop airflow into the vacuum body through the air inlet; and wherein the filter is cleaned by placing the vacuum into:
a first configuration wherein the vacuum motor is operating to draw air from the vacuum body and the air inlet valve is closed to stop airflow into the vacuum body whereby air pressure is reduced in the vacuum body;
a second configuration wherein the air inlet valve is closed and the filter cleaning valve is opened to vent air into the vacuum body downstream of the filter whereby the vent air flows in a reverse direction through the filter to equalize the reduced pressure condition upstream of the filter.

4. The vacuum cleaner of claim 1, wherein the filter cleaning valve comprises a valve and a stem, and wherein opening the filter cleaning valve strikes the filter with the stem.

5. The vacuum cleaner of claim 4, wherein the filter is a rigid filter having a frustoconical shape with an upper size which is smaller than a lower size.

6. The vacuum cleaner of claim 1, wherein the filter cleaning valve comprises a valve stem which extends through the vacuum body and a seal plate attached to the valve stem, wherein the vacuum body comprises a hole formed therethrough, and wherein the valve is moveable between a closed position wherein the seal plate closes the hole through the vacuum body and an open position wherein the seal plate does not close the hole through the vacuum body and the valve stem strikes the filter.

7. The vacuum cleaner of claim 6, further comprising a filter cleaning lever attached to the vacuum body, and wherein movement of the filter cleaning lever opens the filter cleaning valve and strikes the filter.

8. The vacuum cleaner of claim 1, wherein the vent air travels through the filter in a direction which is in reverse of normal vacuum operation to thereby clean the filter while the vacuum motor operates normally to draw air from the vacuum body.

9. A vacuum cleaner comprising:
a vacuum body;
an air inlet which receives debris laden air into the vacuum body;
a cyclone separator disposed in the vacuum body;
a debris collection bin disposed in the vacuum body beneath the cyclone separator such that a bottom debris outlet of the cyclone separator is connected to an upper debris inlet of the debris collection bin;
a filter disposed in the vacuum body which removes debris from the debris laden air. wherein the filter is disposed coaxially around at least one of the cyclone separator and the debris collection bin;
an air outlet port;
a vacuum motor connected to the air outlet port which operates to draw air from the vacuum body and thereby create airflow into the air inlet, through the cyclone separator, and through the filter.

10. The vacuum cleaner of claim 9, further comprising an upstream plenum disposed between the filter and the at least one of the cyclone separator and the debris collection bin.

11. The vacuum cleaner of claim 10, wherein the upstream plenum is annular in shape and wherein the upstream plenum extends between the cyclone separator and the vacuum body.

12. The vacuum cleaner of claim 10, further comprising a downstream plenum disposed between the filter and the vacuum body.

13. The vacuum cleaner of claim 12, wherein the downstream plenum is annular in shape.

14. The vacuum cleaner of claim 12, wherein the vacuum motor is fluidly connected to the downstream plenum and draws air from the downstream plenum, and wherein the vacuum cleaner further comprises a filter cleaning valve which vents air from the environment surrounding the vacuum into the second plenum and wherein said vent air flow in a reverse direction through the filter to clean the filter.

15. The vacuum cleaner of claim 14, wherein the filter cleaning valve comprises a stem which strikes the filter when the valve is opened.

16. The vacuum cleaner of claim 9, wherein debris from the cyclone separator is deposited in the debris collection bin and wherein debris from the filter is deposited between the debris collection bin and the vacuum body.

17. The vacuum cleaner of claim 16, further comprising a dump plate pivotably attached to the vacuum, wherein the dump plate is pivotable between a closed position wherein the dump plate blocks a lower opening on the debris collection bin and blocks a lower opening on the vacuum body and an open position wherein the dump plate is pivoted downwardly away from the debris collection bin and the vacuum body and allows debris to fall from the debris collection bin and the vacuum body into a debris canister.

18. The vacuum of claim 17, further comprising a spring mounted between the dump plate and the vacuum which supports the weight of the dump plate such that the dump plate is held against the debris collection bin and vacuum body when the vacuum is operated and such that the dump plate pivots downwardly and deposits debris into the debris collection canister when the vacuum is not operated.

19. The vacuum of claim 9, wherein the air inlet is connected to a vacuum hose which is used to perform a desired cleaning task, and further comprising a room air cleaning valve which is movable between an open position whereby atmospheric air surrounding the vacuum passes through the room air cleaning valve and enters the cyclone separator with air from the vacuum hose and a closed position whereby atmospheric air does not pass through the room air cleaning valve and air enters the vacuum through the vacuum hose.
